(19) United States
(12) Patent Application Publication
(10) Pub. No.: US 2014/0177459 A1
(43) Pub. Date: Jun. 26, 2014

(54) METHODS AND APPARATUS FOR RAPID AND COST EFFECTIVE TESTING OF WIRELESS SYSTEMS

(71) Applicant: APPLE INC., Cupertino, CA (US)

(72) Inventors: Alf O. Watt, Cupertino, CA (US); David B. Cheung, Cupertino, CA (US); Camille Chen, Cupertino, CA (US); Lei Li, Cupertino, CA (US); Hsin-Yao Chen, Cupertino, CA (US)

(73) Assignee: APPLE INC., Cupertion, CA (US)

(21) Appl. No.: 13/725,801

(22) Filed: Dec. 21, 2012

(51) Int. Cl. H04W 24/00

(52) U.S. Cl. CPC H04W 24/00
USPC 370/252

(57) ABSTRACT

Apparatus and methods for rapid, cost effective testing of wireless systems. In one embodiment, a unit under test (UUT) is tested by a test “server”. The UUT and test server communicate via a “connectionless” protocol which is based on beacons (and beacon responses) which can carry one or more test primitives. The aforementioned “connection-less” test protocol can be performed without wireless network configuration, which greatly reduces test time, Additionally, exemplary solutions are presented for “lock-up” of the UUT and the test server.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technical Field

The present disclosure relates generally to the field of manufacturing and test systems, and more particularly in one exemplary embodiment, to rapid, cost effective testing of wireless devices.

2. Description of Related Technology

Manufacturers typically perform a large number of tests during and after manufacture of an electronic device, so as to inter alia, ensure that devices are constructed properly and operate within acceptable tolerances. Unfortunately, longer test procedures can significantly impact manufacturing throughput; longer test times directly impact the number of units that can be produced in a given time period and hence reduce manufacturing efficiency.

For example, the Assignee hereof implemented factory tests for various wireless-enabled consumer electronic devices circa 2000. Initially, these factory tests were largely focused on wireless local area network (WLAN) performance (according to e.g., the Institute of Electrical and Electronic Engineers (IEEE) 802.11a/b/g/n standards). Early test procedures had a relatively limited number of test cases/configurations, and the overall volume was small, so test time was not a significant factor in manufacturing overhead. However, as consumer electronics have evolved over time, the array of test cases and configurations has grown. Current test procedures test a wide variety of conditions and capabilities, in addition to IEEE 802.11a/b/g/n performance; for example, existing test cases include, inter alia, measurements of platform noise at various conditions (system idle, peak traffic conditions, Universal Serial Bus™ (USB 3.0), Thunderbolt™, High Definition Multimedia Interface™ (HDMI) at 720p and 1080p, active state power management (ASPM), etc.) Bluetooth™ (BT) performance, WLAN/BT isolation, WLAN with 3×3 Multiple Input Multiple Output (MIMO), IEEE 802.11ac WLAN functionality, BT with BTLE (low energy) features, etc. Tests of the foregoing in different physical configurations (e.g., clamshell form factor closed, open, etc.) may also be performed.

Additionally, production volume has significantly increased year-over-year significantly, and hence more devices must be tested in a given time period.

Exemplary incipient manufacturing requirements (e.g., those of the Assignee hereof) require that test suites provide broad test coverage, yet complete under stringent time constraints e.g., less than 120 seconds (2 minutes) for each device. Moreover, future manufacturing needs will require even more functional coverage, and larger production runs. In view of this progressively more challenging trend, new schemes are needed for factory testing. Specifically, improved methods and apparatus are needed for rapid, cost effective testing of wireless devices.

### SUMMARY

The present disclosure satisfies the aforementioned needs by providing, inter alia, improved apparatus and methods for testing of wireless systems.

A method for testing a wireless device is disclosed. In one embodiment, the method includes configuring the wireless device to act at least in part as a wireless network, and transmitting a first signal (e.g., server beacon) from the wireless device identifying the wireless network. Responsive to reception of a response with an embedded message for the wireless network, one or more test procedures from an array of tests are executed based on the embedded message. Results of the one or more test procedures are embedded within a second server beacon, and transmitted. In one exemplary implementation, the server beacon(s) include(s) an Institute of Electrical and Electronic Engineers (IEEE) 802.11 beacon.

In one variant, the server beacon(s) include(s) a header, a frame body and a check sequence. The header may include for example one or more of a source address, a destination address, and/or a unique device identifier associated with the wireless device.

In some variants, the frame body includes a time stamp and one or more information elements. In some instances, at least one information element uniquely identifies a session, and is configured to cause a test server to uniquely associate with the session.

In other variants, the first server signal is a beacon that is transmitted multiple times to facilitate reception.

A method for testing a wireless device with a test server is also disclosed. In one embodiment, the method includes: receiving a first server signal (e.g., beacon) from a wireless device identifying a wireless network; selecting one or more test procedures from a plurality (e.g., an array) of test procedures; embedding a first information element associated with the selected one or more test procedures and a second information element associated with the wireless network within a beacon response; transmitting the beacon response; and responsive to reception of a second server beacon embedded with one or more test results corresponding to the selected one or more test procedures, storing the one or more test results. In one implementation, the beacon response includes an Institute of Electrical and Electronic Engineers (IEEE) 802.11 beacon response.

In one variant, the method further includes verifying a third information element embedded within the first server beacon which uniquely identifies a session with the test server. In some instances, the first server beacon includes a unique identifier. Common examples of a unique identifier include a time stamp, or an incrementing count. In some cases, the method includes comparing the unique identifier against an expected value; and when the unique identifier does not match the expected value, flagging an error. Still other variants may e.g., validate a check sequence embedded within the first server beacon; and when the check sequence is invalid, flag an error.

A wireless device configured to perform one or more tests is also disclosed. In one embodiment, the wireless device includes: a wireless transceiver configured to transmit and receive wireless signals; a processor; and a non-transitory computer readable medium including one or more instructions. In one variant, the one or more instructions are configured to, when executed by the processor, cause the wireless device to: initialize a wireless network; transmit one or more server beacons, the one or more server beacons identifying the wireless network; responsive to reception of a beacon response with an embedded message addressed to the wireless network, determine a test that corresponds to the embedded message according to a test script; and execute the test.

In one variant, the one or more instructions are configured to, when executed by the processor, cause the wireless device to embed one or more test results within one or more first server beacons.

In other variants, the one or more instructions are configured to, when executed by the processor, cause the wireless device to, responsive to reception of a beacon response with an embedded session lock message, lock to a test server.

A test server configured to communicate with a wireless device is further disclosed. In one embodiment, the test server includes: a wireless transceiver configured to transmit and receive wireless signals; a processor; and computerized logic configured to cause the test server to: receive a first server signal (e.g., beacon) from the wireless device, the first server beacon including a unique identifier; select one or more test procedures based on a test script; embed a first information element associated with the selected one or more test procedures and the unique identifier within a beacon response; and transmit the beacon response.

Other features and advantages described herein will immediately be recognized by persons of ordinary skill in the art with reference to the attached drawings and detailed description of exemplary embodiments as given below.

### BRIEF DESCRIPTION OF THE DRAWINGS

FIG. 1 is a logical block diagram representation of an existing All-In-One (AIO) test procedure.

FIG. 2A is an exemplary screen shot of existing test software for the AIO test procedure taken during test initialization.

FIG. 2B is a graphical representation of a device under test (DUT) placed within an existing AIO test fixture.

FIG. 2C is an, exemplary screenshot of existing test software for the AIO test procedure taken after test completion.

FIG. 3 is a logical block diagram of an existing AIO software architecture.

FIG. 4 is a logical flow diagram of the existing AIO test flow for a single test.

FIG. 5 is a logical flow diagram of one embodiment of a generalized method for rapid communication between a unit under test (UUT) and a test server, in accordance with various aspects of the present disclosure.

FIG. 6 is a logical block diagram of one exemplary embodiment of a system for connectionless communication between a UUT and a test server, in accordance with various aspects of the present disclosure.

FIG. 7 is a logical flow diagram of one exemplary embodiment of a lock-up procedure between a UUT and a test server, in accordance with various aspects of the present disclosure.

FIG. 8 is a logical block diagram of an exemplary embodiment of a UUT apparatus.

FIG. 9 is a logical block diagram of an exemplary embodiment of a test server apparatus.

All Figures© Copyright 2012 Apple Inc. All rights reserved.

### DETAILED DESCRIPTION

Reference is now made to the drawings wherein like numbers refer to like parts throughout.

### Overview

The present disclosure provides, inter alia, methods and apparatus for testing of device platforms. In one exemplary embodiment, a wireless device (referred to throughout as the unit under test (UUT)) is tested by a test server. During the testing procedure, the UUT and test server communicate via a “connectionless” protocol which is based on beacons (and beacon responses) which can carry one or more test primitives. Traditional wireless connection schemes require a wireless network search and setup; advantageously, the aforementioned “connection-less” test protocol significantly reduces test setup time.

For reasons described in greater detail hereinafter, the exemplary test server performs a logically distinct function from serving the network. More directly, in one exemplary variant, the UUT (not the test server) configures itself as a wireless local area network (WLAN) server, initializes and performs one or more self driven tests, and embeds the test results and flow control within its own WLAN server beacons. The test server extracts test results and flow control from the transmitted WLAN server beacons, and in some instances provides a user interface (UI) for the test personnel. Where necessary, the test server can transmit a beacon response to signify an acknowledgment (ACK), non-acknowledgement (NAK), flow control response, etc.

Additionally, several procedural optimizations are disclosed. For example, a large testing floor that has multiple connection-less test servers within close physical proximity may inadvertently cause “crossover” signaling between neighboring test systems. Accordingly, various embodiments of the present disclosure additionally provide a so-called “lock-up” scheme whereby the UUT and the test server are locked to one another throughout the test procedure. In another example, the connection-less test procedure may require one or more redundant handshaking procedures to ensure proper communication between the UUT and the test server.

Various other features of the present disclosure will be readily recognized by those of ordinary skill in the related arts, given the contents of the present disclosure.

### Detailed Description of Exemplary Embodiments

Exemplary embodiments are now described in detail. While these embodiments are primarily discussed in the context of a factory manufacturing and test system, it is appreciated that various principles described herein have broader applicability. For example, similar systems may be used by post-manufacture testing for e.g., field diagnostics (e.g., using third party service technicians, etc.), premises diagnostics (e.g., as initiated by the device user, in situ), etc. Moreover, while described herein primarily in the context of commercial or “for profit” manufacturing testing, it will appreciated the various features of the disclosure may be applied to other contexts, including for instance government or military applications.

Additionally, as used herein, the term “test” denotes a procedure intended to elicit a test result. While test results can be a “pass” or a “fail” or binary, it is appreciated that certain tests may not be pass/fail in nature, and may be gradients, or even “fuzzy logic” in nature. For example, calibration tests may return a range of results which are used for adjusting device performance on an individual basis. Calibration tests are commonly used to configure e.g., analog components which may include, for example, radio measurements, touch screen measurements, power (voltage and/or current) measurements, physical switch/button sensitivity, volume adjustment, brightness adjustment, color balance, light sensors (e.g., charge coupled diode (CCD), photo diodes), etc.

Yet other tests may require evaluation by an external device or tester; for example, a device may need to measure or produce a signal which is evaluated by the tester for acceptability. Common examples of such tests include e.g., maximum transmit power, reception gain, etc. Artisans of ordinary skill in the related arts will readily recognize other test types which may be useful in conjunction with the principles disclosed herein.

Additionally, while the following discussions are presented in the exemplary context of two entities (e.g., a UUT and a test server), it is appreciated that various test setups may additionally incorporate a different number of entities (for more complicated test topologies), and/or require the various entities to transition between roles (e.g., transitioning between the testing entity and the tested entity), such variations being readily implemented by one of ordinary skill in the related arts, given the contents of the present disclosure.

While the following description is provided within the context of Wi-Fi and Bluetooth testing, it is appreciated by those of ordinary skill that the various principles described herein are applicable to virtually any wireless communication, including e.g., 3G/LTE, Global Positioning System (GPS), Wireless Microwave Access (WiMAX), Ultra-wideband (UWB), which can benefit from reduced test equipment costs (e.g., by avoiding specialized test equipment).

### Wireless Device Testing Procedures—

Factory tests are often run as part of the Final Assembly Test Process (FATP) for units as they reach the end of the production line. Wireless testing is typically the last step before cosmetic inspection, since wireless testing has to reflect the actual performance of the completely assembled device. Traditionally, wireless testing is performed in an RF shielded chamber (and/or anechoic chamber) which provides isolation from outside noise sources and provides a relatively quiescent environment for noise floor and throughput testing. Since tests can require expensive test equipment which may electronically interfere (or physically impede) other tests, each test is generally conducted in a separate test chamber. Testing personnel manually move the device from chamber to chamber to conduct the full battery of tests. Manual testing had previously been acceptable, since as explained in greater detail below, testing was primarily limited to portable mobile devices which have batteries and are designed for fast wake-up (i.e., no boot procedure).

Unfortunately, consumer electronics have progressed and outgrown the limitations of manual testing. Test times for heavily featured devices are already long; moving a device from one test chamber to another takes even more time, and limits test automation.

Moreover, new types of devices are now tested which are difficult to manually test. For example, desktop computer devices do not have a battery, and must be physically plugged and unplugged from the test chamber.

Worse still, once a desktop computer device is plugged into a new test chamber, the device requires a reboot, which is very time consuming.

The foregoing problems are yet further exacerbated as production volume requirements increase; testing inefficiencies associated with e.g., manual testing of the type described above become increasingly evident and deleterious when multiplied by a large number of devices to be tested.

### All-In-One (AIO) Test Procedures—

In late 2010, the Assignee hereof streamlined certain or its test procedures such that a full array of tests could be performed within a single chamber. The exemplary so-called All-in-One (AIO) test chamber includes a test server that communicates with the device under test (DUT) for each test case. Once all tests have completed, the test server displays a test complete prompt, and the test personnel can take the DUT out of the test chamber. The AIO test procedure significantly reduced test times for e.g., desktop devices, because the DUT was not required to shut down and rebooted between tests/chambers.

In exemplary existing AIO testing implementations, each test has a Device Under Test (DUT) “side script” which is driven by the testing framework. These side scripts correspond to test server scripts; the DUT and test server (also commonly referred to as the “chamber server”) coordinate operations to automate the test procedure. For example, the test server may be required to coordinate the use of interfering radios (e.g., Wi-Fi and Bluetooth) to provide a quiet RF environment for testing. In other examples, the wireless performance of the DUT is measured by the test server (e.g., bandwidth and throughput testing services).

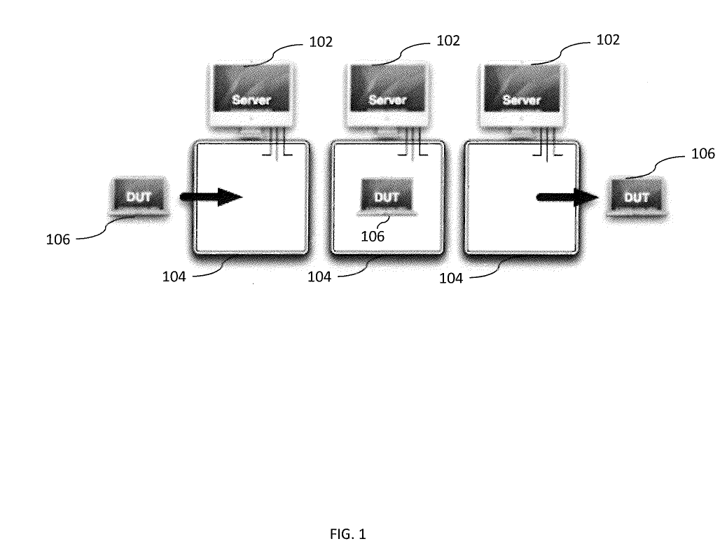

FIG. 1 illustrates one such AIO test procedure. As shown, a test server 102 is coupled to a RF shielded test chamber 104 with RF cabling. The RF cables are coupled to one or more patch antennas within the test chamber. During testing, the DUT 106 is placed inside the test chamber; in some cases, the test chamber may have a physical mounting fixture to hold the DUT.

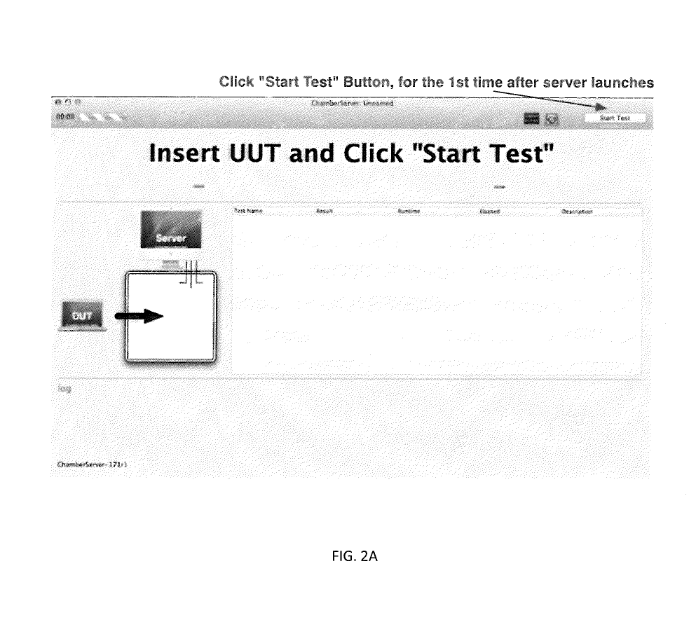

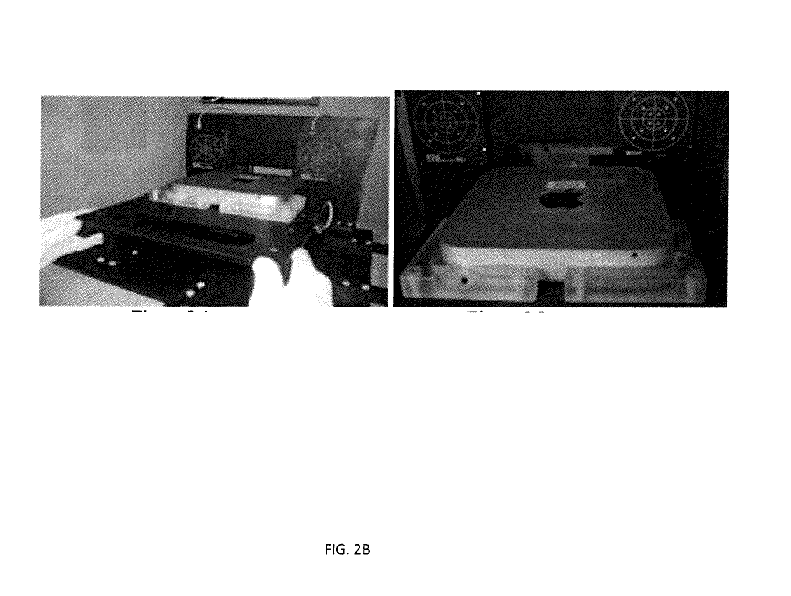

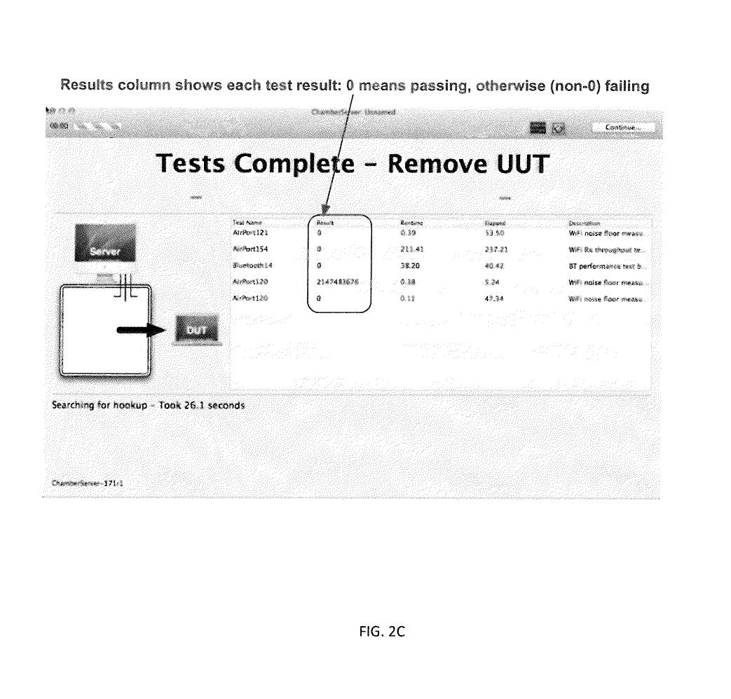

FIGS. 2A, 213, and 2C illustrate an existing AIO test procedure. FIG. 2A is a screenshot of exemplary test software which is executing on the test server; the screenshot is taken at the outset of the test, during test preparation. FIG. 2B illustrates an actual DUT placed within a test chamber. FIG. 2C is a screenshot of the test software after the testing has completed.

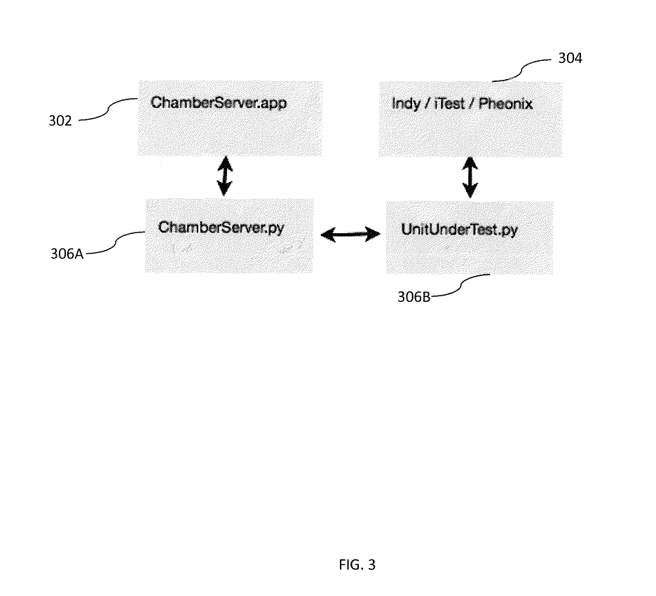

The exemplary test software in the foregoing FIGS. 2A, 2B, 2C utilizes a Cocoa™ based graphical user interface (GUI) which is driven and/or actuates Python™ test scripts. These test scripts may change various components of the user interface (UI): status lines, displayed images, etc. In other examples, the test scripts may initiate a test operation in either the test server or the DUT. FIG. 3 illustrates the aforementioned software architecture. As shown, a chamber server application 302 is executed on the test server, a counterpart DUT application 304 is executed on the DUT, and the test server and DUT communicate with Python scripts (306A, 306B).

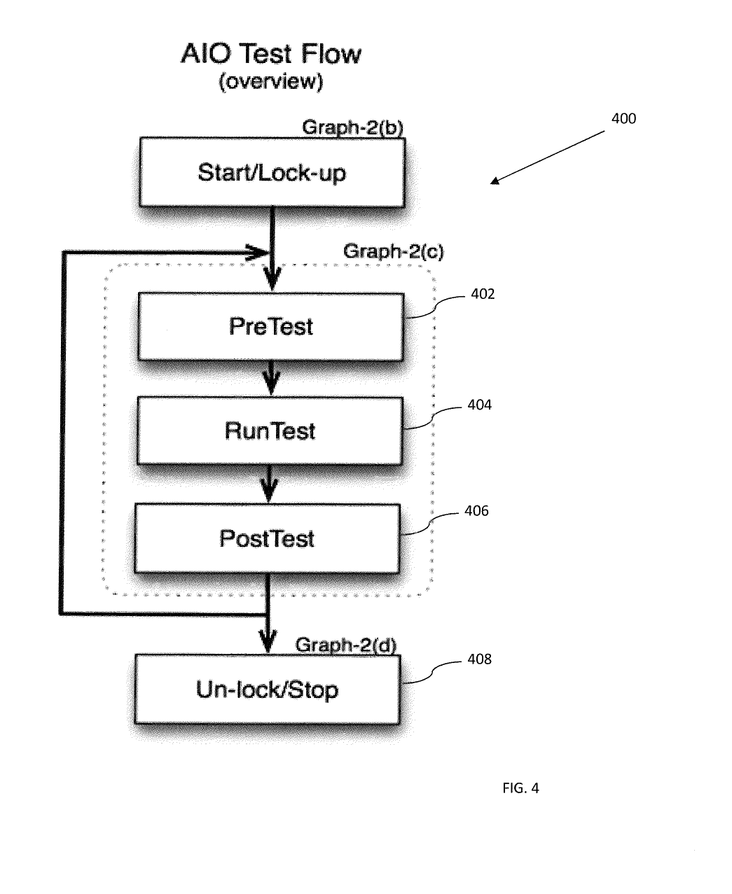

FIG. 4 illustrates the existing AIO test flow 400 for a single test. For each AIO test item, the test flow includes the following stages: “pre-test” procedures, “run test” procedures, and “post test” procedures. Specifically, during pre-test procedures the DUT transfers test parameters to the test server. Thereafter, the DUT and server perform the testing (run test), and once the testing completes, the DUT reports back any test results to the test server during post test procedures.

Referring now to step 402 of the procedure 400, the DUT and test server transact pre-test parameters via a network connection. First, the test server initiates a wireless network, and waits for the DUT to join. The DUT scans until it finds the test server's network. Thereafter, the DUT joins the test server network. Once the network connection is established, the DUT and test server execute pre-test procedures via the network connection. Common examples of pre-test procedures include initialization of variables, warm-up of analog components, configuration of initial conditions, etc. In one such example, the DUT passes one or more test parameters to the test server via the established wireless connection. Finally, in order to reduce noise and/or interference, and ensure accurate testing, the DUT disconnects from the test server, and the test server tears down the wireless network.

At step 404, the DUT and test server execute the test procedure. During the test procedure, the DUT and test server perform the test and/or monitor for one or more results. For example, a DUT may transmit on a first radio interface while the test server monitors for received signal power. In other examples, the DUT may transmit on a first radio interface, and measure the interference on a second radio interface. In still other examples, the test server may transmit, and the DUT may monitor for received signal power. Various other specific examples of wireless tests are well known in the related arts, the foregoing being purely illustrative.

At step 406, the DUT and test server transact post-test parameters via a new network connection. The test server initiates another wireless network, and waits for the DUT to join. The DUT scans until it finds the test server's new network. Common examples of post-test procedures include for example, reporting collected results, resetting variables and/or configurations, cool-down for analog components, etc. In this example, the DUT provides its test results to the test server via the new network connection.

At step 408, the DUT and test server disconnect. Once disconnected, the DUT can be removed from the test server, or another test can be run.

The foregoing AIO test procedure of FIG. 4 has significantly improved test times by reducing the manual steps of the test procedure. However, existing AIO procedures none-the-less spend an inordinate amount of time on wireless connection procedures between the DUT and the test server. Specifically, the DUT has to search for and discover the test server before and after each test.

Those of ordinary skill will further recognize that establishing wireless connections may include additional redundant steps; for example, certain steps may be repeated until successful, and/or the procedure may stall in wait states to ensure that both the DUT and the test server have enough time to synchronize. Moreover, each step includes significant amounts of low-level (frame level) communications and protocol redundancies. For instance, joining a network may require: (i) several full or partial iterations of association request frames transactions between the DUT and test server, (ii) ACK frame responses from the test server to the DUT, (iii) association response frames from the test server to the DUT, and (iv) ACK frames from the DUT to the test server, etc. Consequently, network establishment procedures can take significant amounts of time; e.g., anywhere from 20-40 seconds in commonly encountered scenarios.

For example, the following TABLE 1 below shows a typical set of test cases. As shown, Discovery Transaction #1 and Discovery Transaction #2 are time intervals dedicated to network search and discovery; no “productive” testing is performed during these intervals. Moreover, it is further appreciated that the following table is merely illustrative, additional pre/post test procedures may be required for successful operation in other implementations.

TABLE 1

| | Test | Test | | I/O | |
|---|---|---|---|---|---|
| Category | Number | Time (s) | Description | Device | Comments |
| Wi-Fi | AP #154 | 70 | WLAN Rx + | none | WLAN RSSI and |
| Performance | | | Graphics | | throughput test |
| | | | Processing | | |
| Discovery | | 30-40 | | | |
| Transaction #1 | | | | | |
| BT | BT #14 | 45 | BT Rx/Tx | none | BT RSSI and |
| Performance | | | RSSI + | | throughput test |
| | | | Graphics | | |
| | | | Processing | | |
| Discovery | | 30-40 | | | |
| Transaction #2 | | | | | |
| BTLE | BT #16 | 45 | BTLE Rx/Tx | none | BTLE packages/s |
| Performance | | | RSSI + | | |
| | | | Vertex | | |
| Wi-Fi NF | AP #121 | 60 | WLAN noise | none | WLAN noise floor |
| | | | floor | | test (−dBm) |
| | | | (idle/vertex) | | |
| | | | ASPM off | | |
| BTNF | BT #26 | 30 | BT noise | none | BT noise floor |
| | | | floor | | test (−dBm) |
| Wi-Fi NF | AP #122 | 60 | WLAN noise | Thunderbolt | WLAN noise floor |
| | | | floor | dongle | test (−dBm) |
| | | | (idle/vertex) | | |
| | | | Thunderbolt | | |
| Wi-Fi NF | AP #145 | 60 | WLAN noise | USB 3.0 | WLAN noise floor |
| | | | floor USB 3.0 | dongles | test (−dBm) |
| BT NF | BT #80 | 60 | BT noise | USB 3.0 | BT noise floor |
| | | | floor USB 3.0 | dongles | test (−dBm) |
| Wi-Fi/BT | BT #200 | 60 | WLAN/BT | none | WLAN blasting in |
| isolation | | | isolation | | 2.4 GHz, BT Rx to |
| | | | test | | measure isolation |

Consequently, further improvements are needed to, inter cilia, minimize the transaction time between tests in existing AIO testing. Additionally, as described in greater detail hereinafter, new solutions are also needed to enable “lock-up” procedures between the DUT and the test server. More generally, improved methods and apparatus for testing of wireless devices are needed.

### Methods—

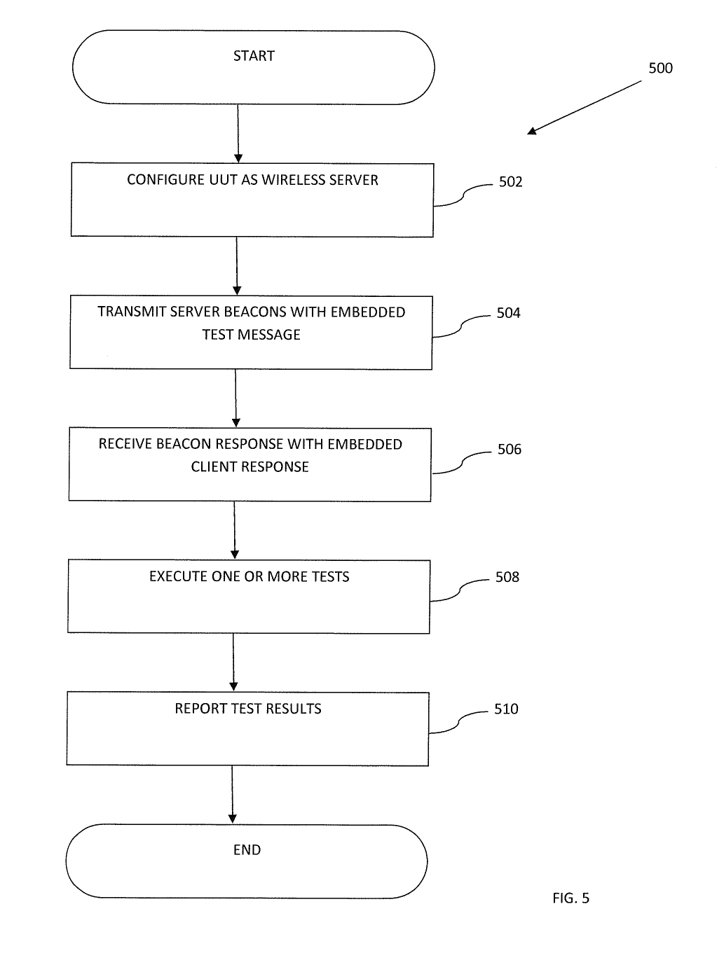

FIG. 5 illustrates one embodiment of a generalized method 500 for rapid, cost effective communication between a unit under test (UUT) and a test server according to the disclosure. In one implementation, the UUT configures itself as a peer-to-peer wireless network access point (AP), and the test server is configured as a wireless client device. Unlike existing test configurations which require the DUT to connect to a wireless network hosted by the test server, the exemplary UUT behaves as an AP, which broadcasts test “primitives” embedded within AP beacon signaling protocols.

By embedding test primitives within beacons (and beacon responses), the UUT can communicate with the test server, without a network connection. More directly, this “connectionless” signaling scheme allows the UUT to send primitive messages without unnecessary connection complexity (e.g., medium access control (MAC), network addressing, session control, etc.). Specifically, due to the relative simplicity of the test procedure format and/or the predetermined test procedure coordination between the UUT test script and the test server test script, the connectionless signaling scheme is sufficient for communication without the overhead associated with normal network communications. This reduction in complexity significantly reduces connection setup and operation time.

At step 502, the UUT configures itself as a wireless server. In one exemplary embodiment, the UUT complies with IEEE 802.11 wireless local area network (WLAN) standards. Other common wireless technologies include e.g., Bluetooth, wireless USB, Zigbee, cellular, WiMAX, etc. It is more generally appreciated that the UUT can configure itself according to virtually any network server, ad hoc network, or peer-to-peer network configuration.

In some variants, server configuration may be selectively limited to a subset of server functionality. For example, “server configuration” may be limited to the necessary hardware and software processes for only the transmission of one or more server beacons. In other variants, server configuration may encompass additional network functionality (e.g., network address capabilities, resource allocation, network identification, etc.). Combinations of the foregoing under different operational scenarios and/or modes are also contemplated by the present disclosure.

At step 504, the UUT transmits a server beacon with an embedded test message. In one embodiment, the server beacon is a special control message provided for within Institute of Electrical and Electronic Engineers (IEEE) 802.11 based wireless local area networks (WLAN). Typically, the beacon signaling contains information about the transmitting access point (AP). While the following embodiments are discussed in the context of IEEE 802.11 beacons, it is appreciated that, inter alia, any random access signaling scheme may be used. As a brief aside, in server network topologies, a server controls access to network resources among a population of client devices. Thus, a server can arbitrarily or “randomly” assume control of a resource (such as a time slot, frequency band, etc.). It is appreciated that in other network topologies (e.g., ad hoc networks, peer-to-peer networks, etc.), other schemes for access may exist. For example, peer-to-peer networks may have a contention based access scheme, where a device sends a random access probe to initiate data transactions. Similarly, ad hoc networks may have signaling analogous to the aforementioned beacon signaling, etc.

In one embodiment of the present disclosure, the beacon minimally includes a header, a frame body, and a check sequence. The header may include e.g., identification of the server (e.g., the UUT), source address, destination address, etc. Server identification may be a random, pseudo-random, or fixed identification. For example, the server identification may be based on a unique device identifier of the UUT and/or a random nonce, etc. The source address and device address may be hardcoded, trivially determined, or actively determined. For example, in a “trivially determined” embodiment, the source address of the device is a default server Internet protocol (IP) address (e.g., 192.168.0.1), and the destination address of the device is a broadcast address (e.g., 255.255.255.255). In an actively determined embodiment, the destination address of the device would correspond to the test server (which would require the test server being assigned an IP address, e.g., via network registration, etc.).

In one embodiment, the frame body commonly includes a time stamp, and one or more test primitives embedded within one or more information elements. The test primitives can be configured for instance to start a test, stop a test, control test flow (e.g., pause, skip, etc.), report test results, set up one or more initial conditions for the test, lock to a test server, unlock a test server, etc., or any combinations of the foregoing.

In one such embodiment, the test primitives are constructed of one or more of e.g., operational codes (opcodes), reference values, operand values (or immediate values), etc. An opcode includes in one implementation a uniquely identifiable string which indicates an operation to be performed. A reference value is a value which must be “de-referenced” for use. Common examples of a reference value include an address, a register, a pointer, etc.). Operand values are values which can be used immediately (i.e., the operand value is used).

In one embodiment, a check sequence is provided that can be used by the test server to verify the contents of the test message. Common examples of check sequences include cyclic redundancy checks (CRC), parity checks, checksums, hash functions, etc.

Various other types of management frames which may be configured to augment or substitute for beacons include without limitation: authentication frames, de-authentication frames, association request frames, re-association request frames, and probe request frames. It is additionally appreciated that in some variants, proprietary or otherwise specialized message types may be used.

At step 506, the UUT receives a response with an embedded client message response. In one embodiment, the response is an acknowledgment (ACK) or non-acknowledgement (NACK) message. ACK and NACK signaling may be used for instance to indicate if the message has been received correctly based on e.g., a checksum or CRC check. In other variants, the ACK and NACK signaling may include one or more test primitives embedded within information elements. Typical examples of response test primitives include starting a test, stopping a test, confirming test results, setting up one or more initial conditions for the test, locking to the UUT, unlocking to the UUT, etc.

Various other exemplary types of management frames which may be configured to augment or substitute for beacon responses consistent with the disclosure include, without limitation: association response frames, re-association response frames, and probe response frames.

Those of ordinary skill in the related arts will recognize that the aforementioned connectionless transactions of step 504 and step 506 may not provide the same level of transaction reliability which a typical network connection would (e.g., delivery guarantees, retransmission, etc.). Accordingly, various embodiments provide limited connection capabilities based on specialized information elements.

For example, since traditional checking and retransmission schemes may not be used to resolve corrupted or missed transmissions, various embodiments of the UUT and/or test server are configured to transmit multiple times. In one such variant, the UUT may transmit a message multiple times to ensure that the communication is received by the test server. In some implementations, the message may be transmitted a fixed number of times. In other implementations, the message may be transmitted until a response is received. In still other implementations, the message may be retransmitted in response to unexpected behavior from the test server. For instance, in one exemplary case, the UUT repeats a message within a beacon for 4 (four) transmissions; since the time between each beacon is approximately 100 milliseconds, this represents approximately a 400 millisecond window of time during which the test server can receive the message. In other embodiments, the beacon has a programmable time interval; one such example is the IEEE Delivery Traffic Indication Message (DTIM). Traditionally, DTIM messaging is configured to provide information regarding a buffered multicast/broadcast data on the access point at programmable time intervals. However, in one exemplary variant, the test messaging is transmitted on DTIM beacons according to the DTIM interval. By changing the DTIM interval, the test procedure can e.g., reduce power consumption by lengthening intervals, speed up test times by shortening intervals, etc.

Notwithstanding the foregoing, it is recognized that some other gains in reliability may be realized using the less complex protocols, simply by virtue of their simplicity (i.e., less “moving parts”, and hence less to fail).

In some embodiments, each message is uniquely identifiable from other messages. Common examples of unique identifiers include e.g., an incrementing count, a time stamp, etc. Unique identifiers can be used by the receiver of the message to determine if one or more messages have been lost. For example, each unique message embedded within a beacon may include a unique, incrementing/sequential ID. Each time the test server receives a beacon, the embedded ID is verified against its expected value. If the embedded ID does not match the expected value, then the test server can flag an error, and/or institute remedial action (such as a retransmission, change of transmission parameter(s) to enhance the likelihood of a successful reception, etc.).

In still other embodiments, the UUT and/or test server may have one or more “return” conditions, where either one or both of the UUT and/or test server return to a known state. In some variants, both the UUT and test server default to the reset state for unexpected transactions. In other cases, the UUT and test server may return to the last known “good” state, to re-attempt the transaction (e.g., test, etc.). In some instances, the number of re-attempts may be limited, after which the test moves on to the next test in the array of tests, or alternately fails and exits the testing sequence.

In some embodiments, the UUT and/or test server may include a session lock. Session locks ensure that the message transactions between the UUT and the test server are actually intended for the recipient. For example, in typical manufacturing facilities, there are hundreds of chambers within relatively close proximity. Operators open and close the chambers to change devices (which occurs for each chamber every couple of minutes). Accordingly, in order to prevent crossover mismatches (i.e., where a neighboring test server connects with the wrong UUT), a lock-up procedure between the test server and UUT ensures that communications for neighboring systems do not interfere. In one such example, when a UUT is inserted within a test server, the UUT and test server perform a simple handshake procedure which assigns a unique identifier to the session. Thereafter, subsequent communications are identified with the unique identifier. Neighboring transactions will be identified with a different identifier, and can be ignored. It will be appreciated, however, that other methods of ensuring that communications intended for only one or more particular recipients can be utilized consistent with the disclosure, such as e.g., security measures (e.g., hashing, encryption, etc.), unique pseudo-random noise (PN) spreading codes or hopping sequences on the air interface, etc.

In some cases, the lock-up may be manually verified by a human. In other variants, the lock-up may be verified by the test server and/or UUT. In still other variants, the lock-up procedure may be based on a mechanical trigger (e.g., when the test fixture closes, the UUT and the test server lock). Those of ordinary skill in the related arts will readily recognize other forms of lock-up procedures, given the contents of the present disclosure.

In other variants, the session may be uniquely associated with one or more device identifiers. For example, in scenarios with multiple UUTs or test servers, each device may be uniquely identified, such that messages can be intended for a recipient can be ignored by the other devices.

Additionally it is appreciated that various embodiments may require additional connection capabilities such as flow control, multiplexing control, etc. For example, it is appreciated that as technology continues to progress, a UUT may be able to report faster or slower than a test server can service. This may occur as test servers are adapted to suit a population of different devices and/or device revisions. Flow control ensures that the UUT (or alternately the test server) manages the rate of data transmission to prevent the transmitter from outrunning a slower receiver. Similarly, it is appreciated that in some embodiments, where a device has multiple wireless interfaces (e.g., Wi-Fi, Bluetooth, etc.), congestion control and/or multiplexing may be used to improve connection reliability. For example, the UUT may schedule reporting on its Wi-Fi interface to occur at a different time interval from the Bluetooth interface, so as to prevent unnecessary interference in the overlapping frequency band(s). Moreover, the UUT may utilize congestion control techniques to minimize the impact on/from neighboring systems (which are likely also reporting at similar time intervals.

Returning again to FIG. 5, at step 508, the UUT executes one or more test procedures from an array of tests based on the embedded test message, and at optional step 510, one or more results of the one or more test procedures is reported.

In one exemplary embodiment, the UUT and test server are configured with complementary test scripts which are coordinated based on the embedded test messages. For example, as previously discussed, messages from the UUT are configured to e.g., start a test, stop a test, control test flow (e.g., pause, skip, etc.), report test results, set up one or more initial conditions for the test, lock-up to the test server, unlock a test server, etc. Each of these test messages corresponds to an appropriate and complementary action within the test server. For example, where a UUT transmits a message configured to start a test, the test server will responsively e.g., provide test stimulus or monitor test behavior (based on the requirements of the test). In another such example, where a UUT transmits a message requesting test results, the test server responsively responds with the results of the test.

At the conclusion of the array of tests, the UUT and/or test server compile the test results for the array of tests, and provide this information in a report or digest for the test personnel. In some variants, the UUT and test server unlock from one another. Additionally, in some variants, test personnel are further notified via one or more of e.g., a graphical user interface (GUI), an indicator lamp, an audible sound, email or short message service (SMS) text message, etc.

### Example Operation—

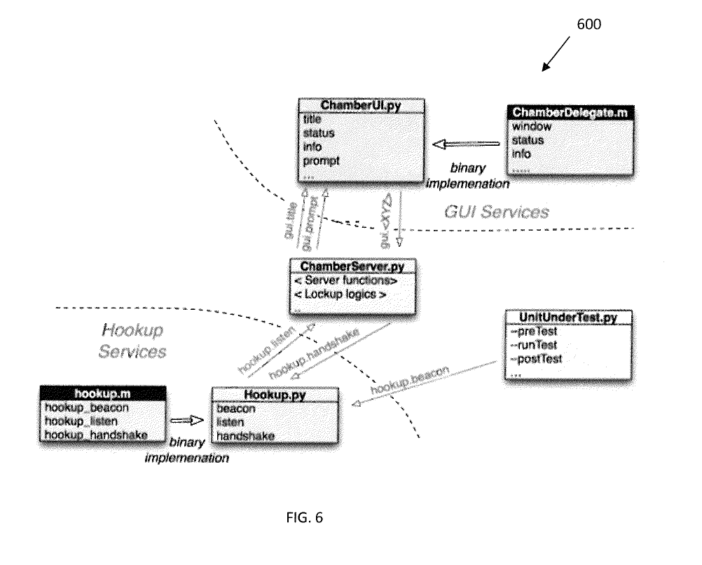

Referring now to FIG. 6, is a logical block diagram of one exemplary implementation of a system 600 for connectionless communication between a UUT and a test server according to the disclosure. As shown, a UUT and a test server utilize a beacon/IE (information element) based communication protocol embodied within e.g., an exemplary hookup.services script and software. Hookup.services is selected in this exemplary illustration in that it provides extremely fast, non-connection oriented (connectionless) communications between the test server and the UUT. Specifically, hookup.services work directly with low-level beacon and ACK frames to simplify the test information transfer mechanism between the UUT and test server, which greatly reduces the complexity and time during pretest and post test procedures. The fast-handshake protocol embeds test primitives (e.g., parameters, results, etc.) in the information element (IE) field of the beacon frame.

As previously described, existing test systems require a DUT to connect to the chamber server between tests; this connection process requires a TCP-IP network connection to the chamber server's network, which could take 20-40 seconds to establish. The following example refers to the test server as the “Chamber Server” for historical reasons, however this is a misnomer, as the test server is not operating as an IEEE 802.11 access point (AP). Rather, the UUT has enabled limited AP beacon transmission capabilities. IEEE 802.11 beacon frames are broadcast on 100 millisecond intervals until the receiver receives the beacon and responds with an ACK. This process generally concludes in less than 400 milliseconds.

Specifically, the UUT implements a connectionless protocol to communicate test primitives on AP beacons. This beacon communication directly translates to reduced test times. Effectively, the “zero overhead” for test SW automation over wireless links advantageously will greatly reduce factory per-unit test time (minimal operator attendance, almost no handling overhead, cable-less, etc). In some cases, UUTs can even share test servers for different test items that originally required different chamber setups, etc.

The exemplary hookup services test scripts are implemented in the exemplary illustration within Python script (.py), whereas the hookup services back-end software is implemented within the C language (.m), and is configured to the device specific application programming interface (API). Those of ordinary skill in the related arts will readily recognize that test scripts are programs that are limited to automation of tasks which could alternatively be executed one-by-one by a human operator, or yet other alternative mechanisms. For example, a test script command might be mouse.clickOn(x,y) where x and y denote a coordinate of the mouse pointer; file.open(foo) is an example of test script command to open a file foo. Unlike so called “compiled” programs, scripts (and other interpreted programming languages) can be written and executed “on-the-fly” without explicit compilation, linking, etc.; compiled programs are optimized machine code formats which are not human-readable.

The exemplary UnitUnderTest.py is a test script executing from the UUT which is configured to transmit test primitives for initializing tests (e.g., preTest routine), running tests (e.g., runTest routine), and ending tests (e.g., postTest routine). Test primitives are embedded within a set of information elements that are transmitted within the hookup.beacon transmission corresponding to the desired routine.

Hookup.py is a test script executing from the test server which interfaces to the hookup.m test program. Hookup.py is configured to report information to the GUI (beacon routine), listen for beacons (listen routine), and respond to the UUT beacons (handshake routine) via ACK/NACK signaling.

ChamberServer.py is a test script executing from the test server which is configured with the test server logic (server functions), and lock-up logic (described in greater detail hereinafter). ChamberUI.py and ChamberDelegate.m provide a GUI for test personnel control.

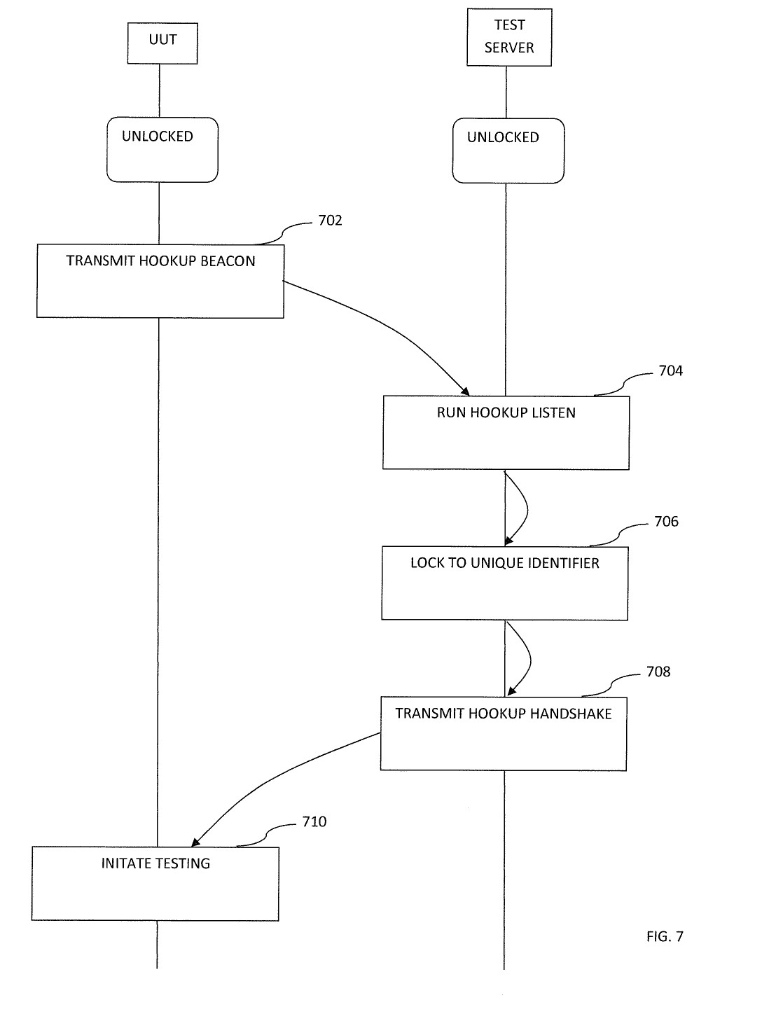

FIG. 7 provides a logical flow diagram representative of an exemplary lock-up procedure 700 according the disclosure. As shown, the test server (“server”) and UUT start in an unlocked state.

At step 702, the UUT transmits a hookup.beacon that includes a lock-up information element message. Included within the lock-up message is a unique identifier for the UUT.

At step 704, the test server runs a hookup.listen routine to receive a hookup.beacon with a lock-up message. When a hookup.beacon with a valid lock-up message is received, the test server locks to the unique identifier of the UUT (step 706), and transmits a hookup.handshake with its own unique identifier (step 708).

Once the UUT receives the corresponding handshake, the UUT and server are “locked” and can initiate testing (step 710).

### Apparatus—

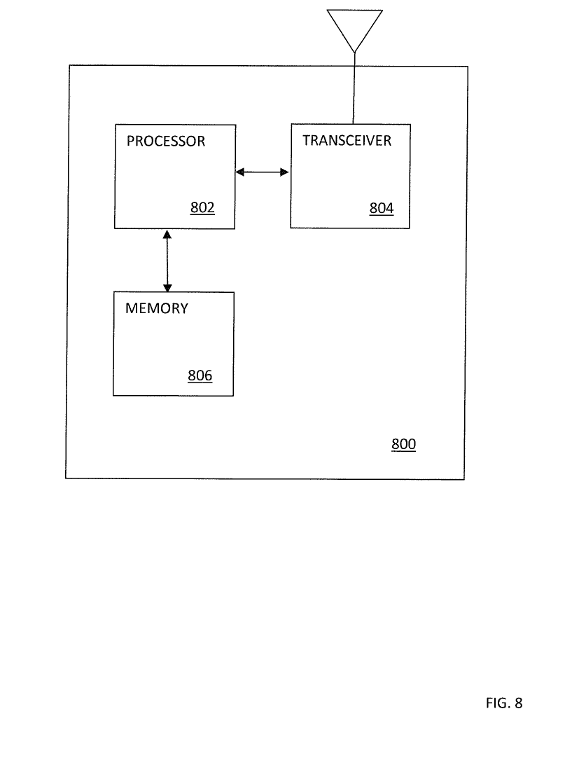

Referring now to FIG. 8, an exemplary unit under test (UUT) apparatus 800 is depicted. While a specific device configuration and layout is shown and discussed, it is recognized that many other implementations may be readily implemented by one of ordinary skill given the present disclosure, the apparatus 800 of FIG. 8 being merely illustrative of the broader principles.

In the illustrated embodiment, the apparatus 800 includes a wireless device such as a portable (laptop or handheld) computer (e.g., Macbook™, MacBook Air™, MacBook Pro™, Mac Mini™, iMac™, Mac Pro™, or iPad or iPad mini, each of the foregoing manufactured by the Assignee hereof), mobile communications device (e.g., cellular phone, 3G “UE” or smartphone (e.g., iPhone™ manufactured by the Assignee hereof), PDA, access point (e.g., AirPort™ manufactured by the Assignee hereof), digital media receivers (e.g., AppkTVT™ manufactured by the Assignee hereof), etc.). In other embodiments, the apparatus includes a desktop computer, server computer, or so-called “blade” or array computer. Those of ordinary skill in the related arts will readily appreciate that the various principles described herein are applicable to a wide variety of device types, configurations, and/or functions.

As shown in FIG. 8, the UUT apparatus 800 includes a processor 802, at least one wireless transceiver subsystem 804, and a non-transitory computer-readable medium 806 or other computerized logic.

The processing subsystem 802 includes a central processing unit (CPU) or digital processor 802, such as a microprocessor, digital signal processor, field-programmable gate array, array processor, or plurality of processing components mounted on one or more substrates. The processing subsystem is tightly coupled to operational non-transitory computer-readable medium 806 which may include for example SRAM, FLASH and SDRAM components. The processing subsystem may also include additional co-processors (not shown), such as a dedicated graphics accelerator, network processor (NP), audio processor, or even a dedicated test co-processor. The processing subsystem 802 is configured to execute one or more test scripts and back-end software.

In alternate embodiments (not shown), the UUT apparatus 800 may include dedicated logic configured to initialize, execute, and report results for one or more tests of an array of tests. Common examples of such logic include e.g., application specific integrated circuits (ASIC), programmable logic devices (PLDs), field programmable gate arrays (FPGAs), gate array logic (GAL), programmable array logic (PAL), and/or reconfigurable logic fabrics, etc.

The wireless transceiver subsystem 804 includes one or more components which are configured to transmit and receive wireless signals for wireless communication. Wireless transceivers typically include one or more antennas, amplifiers, analog to digital (A/D) converters, digital to analog (D/A) converters, automatic frequency control (AFC), automatic gain control (AGC), baseband processors (BB), etc. Due to the exacting nature of RF transmission, wireless transceiver subsystems can usually be treated in aggregated whole e.g., a whole WLAN subsystem, a whole BT subsystem, a whole cellular subsystem, etc. Moreover, it is appreciated that as wireless technologies have converged and evolved, wireless subsystems have adapted accordingly. For instance, combined WLAN/BT subsystems are commonly used in place of discrete WLAN and BT subsystems.

Various embodiments may further include a user interface system that may include any number of well-known I/O devices including, without limitation: a keypad, mouse, touch pad, touch screen, display, backlights, LEDs, speaker, and microphone.

Exemplary embodiments are further configured to operate as a wireless network server. In one exemplary embodiment, the apparatus 800 complies with IEEE 802.11 wireless local area network (WLAN) standards. Other common wireless technologies include e.g., Bluetooth, wireless USB, Zigbee, cellular, etc. In certain variants, the apparatus can configure itself to accommodate, ad hoc networking, and/or peer-to-peer networking configurations.

In one embodiment, the apparatus is configured to transmit one or more server signals (e.g., beacons) which contain one or more embedded test messages. In one variant, the beacon minimally includes a header, a frame body, and a check sequence, such as are described supra.

In one embodiment of the apparatus 800, the apparatus is further configured to receive a response with an embedded client message response. In one exemplary variant, the response is an acknowledgment (ACK) or non-acknowledgement (NACK) message.

Various other configurations for supporting connectionless transactions will be recognized by those of ordinary skill in the related arts, given the contents of the present disclosure.

In one variant, the apparatus 800 is further configured to transmit one or more beacons and/or beacon responses multiple times. In some cases, the message may be transmitted a fixed number of times. In other variants, the message may be transmitted until a response is received. In still other variants, the message may be retransmitted in response to unexpected behavior from the test server. In some implementations, the beacons and/or beacon responses are uniquely identifiable from other messages.

In some embodiments, the apparatus is configured to lock to a test server for the duration of a testing session. The session lock ensures that the message transactions between the UUT and the test server are not inadvertently received from (or transmitted to) nearby test stations. In some cases, the lock-up may be manually verified by a human. In other variants, the lock-up may be verified by the test server and/or UUT based on e.g., a messaging exchange, a mechanical trigger, etc.

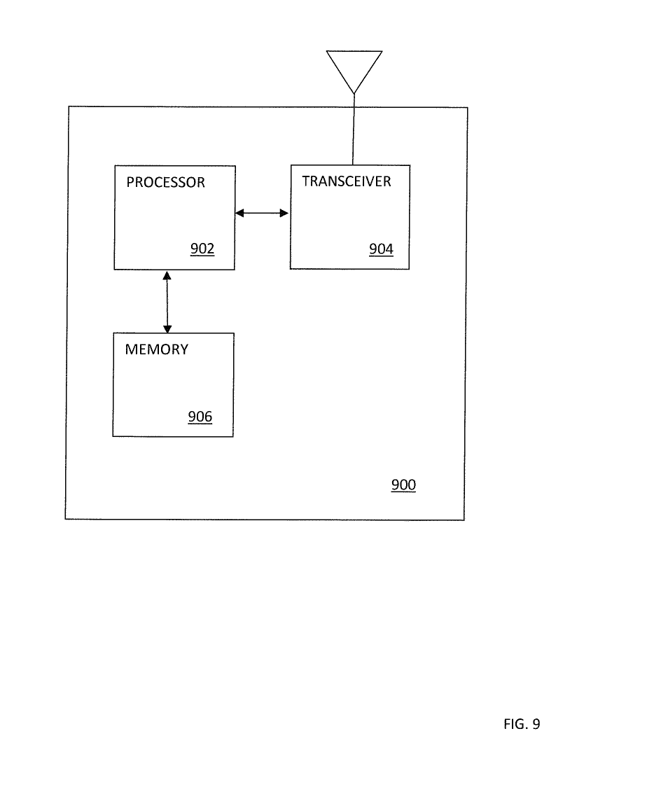

Referring now to FIG. 9, an exemplary test server apparatus 900 is depicted. While a specific device configuration and layout is shown and discussed, it is recognized that many other implementations may be readily implemented by one of ordinary skill given the present disclosure, the apparatus 900 of FIG. 9 being merely illustrative of the broader principles.

In the illustrated embodiment, the test server 900 is a wireless device such as e.g., a desktop test “server” with wireless capabilities. Various alternative embodiments may be based on e.g., a handheld or tablet computer, a desktop computer, blade array, etc. Those of ordinary skill in the related arts will readily appreciate that the various principles described herein are applicable to a wide variety of device types, configurations, and/or functions.

As shown in FIG. 9, the test server includes a processor 902, at least one wireless transceiver subsystem 904, and a non-transitory computer-readable medium 906.

The processing subsystem 902 includes a central processing unit (CPU) or digital processor 902, such as a microprocessor, digital signal processor, field-programmable gate array, array processor, or plurality of processing components mounted on one or more substrates. The processing subsystem is tightly coupled to operational non-transitory computer-readable medium 906 which may include for example SRAM, FLASH and SDRAM components. The processing subsystem may also include additional co-processors (not shown), such as a dedicated graphics accelerator, network processor (NP), audio processor, or even a dedicated test co-processor. The processing subsystem 902 is configured to receive and store test results transmitted from a UUT (e.g., the aforementioned UUT 800 of FIG. 8).

It will be recognized that while certain embodiments are described in terms of a specific sequence of steps of a method, these descriptions are only illustrative of the broader methods of the present disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the principles disclosed and claimed herein.

While the above detailed description has shown, described, and pointed out novel features of the various embodiments, it will be understood that various omissions, substitutions, and changes in the form and details of the device or process illustrated may be made by those skilled in the art. The foregoing description is of the best mode presently contemplated. This description is in no way meant to be limiting, but rather should be taken as illustrative of the general principles. The scope of the present disclosure should be determined with reference to the claims.

What is claimed is:

1. A method for testing a wireless device, comprising:
configuring the wireless device to act at least in part as a wireless network;
transmitting a first signal from the wireless device identifying the wireless network;
responsive to reception of a response with an embedded message for the wireless network, executing one or more test procedures from an array of tests based on the embedded message;
embedding the one or more results of the one or more test procedures within a second signal; and
transmitting the second signal.

2. The method of claim 1, wherein the first and second signals each comprise a server beacon.

3. The method of claim 2, where the server beacons each comprise an Institute of Electrical and Electronic Engineers (IEEE) 802.11 beacon.

4. The method of claim 2, where the server beacons each comprise a header, a frame body and a check sequence.

5. The method of claim 4, where the header comprises a source address and a destination address.

6. The method of claim 4, where the header comprises a unique device identifier associated with the wireless device.

7. The method of claim 4, where the frame body comprises a time stamp and one or more information elements.

8. The method of claim 7, where at least one of the one or more information elements uniquely identifies a session and is configured to cause a test server to uniquely associate with the session.

9. The method of claim 1, where the first signal is transmitted multiple times to facilitate reception.

10. A method for testing a wireless device with a test server, comprising:
receiving a first server signal from a wireless device, the first signal identifying a wireless network;
selecting one or more test procedures from a plurality of test procedures;
embedding a first information element associated with the selected one or more test procedures and a second information element associated with the wireless network within a response;
transmitting the response; and
responsive to reception of a second server signal comprising one or more test results corresponding to the selected one or more test procedures, storing the one or more test results.

11. The method of claim 10, where the response comprises an Institute of Electrical and Electronic Engineers (IEEE) 802.11 beacon response.

12. The method of claim 10, further comprising verifying a third information element embedded within the first server signal which uniquely identifies a session with the test server.

13. The method of claim 10, where the first server signal includes a unique identifier.

14. The method of claim 13, where the unique identifier comprises a time stamp.

15. The method of claim 13, where the unique identifier comprises an incrementing count.

16. The method of claim 13, further comprising:
comparing the unique identifier against an expected value; and
when the unique identifier does not match the expected value, flagging an error.

17. The method of claim 10, further comprising:
validating a check sequence embedded within the first server beacon; and
when the check sequence is invalid, flagging an error.

18. A wireless device configured to perform one or more tests, the wireless device comprising:
a wireless transceiver configured to transmit and receive wireless signals;
a processor; and
a non-transitory computer readable medium comprising one or more instructions that are configured to, when executed by the processor, cause the wireless device to:
initialize a wireless network;
transmit one or more server signals, the one or more server signals identifying the wireless network;
responsive to reception of a response comprising an embedded message addressed to the wireless network, determine a test that corresponds to the embedded message according to a test script; and
execute the test.

19. The wireless device of claim 18, where the one or more instructions are further configured to, when executed by the processor, cause the wireless device to embed one or more test results within one or more first server signals configured to report the one or more test results

20. The wireless device of claim 18, where the one or more instructions are further configured to, when executed by the processor, cause the wireless device to, responsive to reception of response with an embedded session lock message, lock to a test server.

21. A test server configured to communicate with a wireless device, the test server comprising:
a wireless transceiver configured to transmit and receive wireless signals;
a processor; and
computerized logic in communication with the processor and configured to cause the test server to:
receive a first server signal from the wireless device, the first server signal comprising a unique identifier;
select one or more test procedures based on a test script;
embed a first information element associated with the selected one or more test procedures and the unique identifier within a response; and
transmit the response.
